(19) United States
(12) Patent Application Publication
(10) Pub. No.: US 2019/0354502 A1
(43) Pub. Date: Nov. 21, 2019

(54) LIGHTWEIGHT UNIVERSAL SERIAL BUS (USB) COMPOUND DEVICE IMPLEMENTATION

(71) Applicant: QUALCOMM Incorporated, San Diego, CA (US)

(72) Inventors: Tomer Rafael Ben-Chen, Amikam (IL); Lior Amarilio, Yokneam (IL); Sharon Graif, Zichron Yaakov (IL)

(21) Appl. No.: 16/409,030

(22) Filed: May 10, 2019

Related U.S. Application Data
(60) Provisional application No. 62/674,352, filed on May 21, 2018.

(51) Int. Cl. G06F 13/40; G06F 13/42; G06F 11/10

(52) U.S. Cl. CPC G06F 13/4027; G06F 13/4282; G06F 2213/0042; G06F 2213/0026; G06F 11/1004

(57) ABSTRACT

Lightweight Universal Serial Bus (USB) compound device implementation is disclosed. In particular, a compound device is provided that includes a parsing circuit that parses addresses and endpoint values for comparison to a look-up table and translation thereof for provision of updated addresses and endpoint values to a USB device controller. The USB device controller then uses the updated endpoint values to route information to a correct destination. In this manner, the benefits of a USB compound device are provided without the area and power penalty that normally accompanies a USB compound device.

### PRIORITY CLAIM

The present application claims priority to U.S. Provisional Patent Application Ser. No. 62/674,352 filed on May 21, 2018 and entitled “LIGHTWEIGHT UNIVERSAL SERIAL BUS (USB) COMPOUND DEVICE IMPLEMENTATION,” the contents of which is incorporated herein by reference in its entirety.

### BACKGROUND

### I. Field of the Disclosure

The technology of the disclosure relates generally to an interface capable of supporting multiple Universal Serial Bus (USB) devices.

### II. Background

Computing devices are common in modern society. The prevalence of these devices is explained, in part, by the myriad functions which are enabled by these devices. Some of these myriad functions are enabled through different devices or specialized integrated circuits (ICs). Various protocols have evolved to enable such different devices and ICs to communicate with one another.

One popular protocol is the Universal Serial Bus (USB) protocol. USB 3.0 was released Nov. 12, 2008 and version 3.1 was released in July 2013. While the protocol is popular due to its great flexibility, many portable computing devices are space limited to a single USB receptacle. Such a situation may be limiting where multiple USB devices are desired. For example, a user may wish to connect a keyboard and a mouse to a laptop. Two approaches have been taken to provide flexibility to this single-receptacle limitation.

A first approach is a “composite device” that integrates several functions into the same device. This device occupies only a single USB device address and uses a single hardware controller to route signals to the appropriate circuitry and/or software within the device. In general, such composite devices lack flexibility to provide desired functionality. This lack of flexibility derives from the fact that composite devices must prepopulate possible configurations and cannot readily accommodate a configuration that is not so prepopulated (e.g., when a track ball is added to a keyboard and mouse setup). A second approach is a “compound device” which includes a USB hub and several USB devices contained in a single physical device. Compound devices allow for each device to be allocated a different address and a straightforward hardware implementation, but having multiple devices within a single physical device comes at an area penalty and/or higher development cost. Thus, there is a desire to have a better way to accommodate multiple USB devices through a single receptacle.

### SUMMARY OF THE DISCLOSURE

Aspects disclosed in the detailed description include a lightweight Universal Serial Bus (USB) compound device implementation. In particular, a compound device is provided that includes a parsing circuit that parses addresses and endpoint values for comparison to a look-up table and translation thereof for provision of updated addresses and endpoint values to a USB device controller. The USB device controller then uses the updated endpoint values to route information to a correct destination. In this manner, the benefits of a USB compound device are provided without the area and power penalty that normally accompanies a USB compound device.

In this regard in one aspect, a method for using multiple USB devices through a single USB receptacle on a host is disclosed. The method includes, at a hub, receiving a token from a host. The method also includes checking a cyclic redundancy check (CRC) value. When the CRC value is valid, the method includes replacing an address and an endpoint value within the token with a modified address and a modified endpoint value. The method also includes passing an updated token to a device controller.

In another aspect, a USB hub is disclosed. The USB hub includes a USB physical layer (PHY). The USB hub also includes a first USB Transceiver Macrocell Interface (UTMI) bus coupled to the USB PHY. The USB hub also includes a second UTMI bus. The USB hub also includes a parsing circuit connected to the first UTMI bus and the second UTMI bus. The USB hub also includes a device controller coupled to the second UTMI bus. The parsing circuit is configured to receive a token from a host. The parsing circuit is also configured to check a CRC value. When the CRC value is valid, the parsing circuit is configured to replace an address and an endpoint value within the token with a modified address and a modified endpoint value. The parsing circuit is also configured to pass an updated token to the device controller.

In another aspect, a USB hub is disclosed. The USB hub includes a USB PHY. The USB hub also includes a UTMI bus coupled to the USB PHY. The USB hub also includes a device controller coupled to the UTMI bus. The device controller includes a parsing circuit and a pair of taps. The pair of taps provides information to a look-up table. The look-up table is configured to replace an address and an endpoint value within a token with a modified address and a modified endpoint value. The look-up table is also configured to pass an updated token to the device controller.

In another aspect, a USB hub is disclosed. The USB hub includes a USB PHY. The USB hub also includes a first bus coupled to the USB PHY. The USB hub also includes a second bus. The USB hub also includes a parsing circuit connected to the first bus and the second bus. The USB hub also includes a device controller coupled to the second bus. The parsing circuit is configured to receive a token from a host. The parsing circuit is also configured to check a CRC value. When the CRC is valid, the parsing circuit is configured to replace an address and an endpoint value within the token with a modified address and a modified endpoint value. The parsing circuit is also configured to pass an updated token to the device controller.

### BRIEF DESCRIPTION OF THE FIGURES

FIG. 1 is a simplified illustration of a computing system coupled to a plurality of auxiliary devices through a single Universal Serial Bus (USB) receptacle;

FIG. 2 is a block diagram of an exemplary conventional USB compound device controller;

FIG. 3 is a block diagram of an exemplary lightweight USB compound device controller with a parsing circuit according to an exemplary aspect of the present disclosure;

FIG. 4 is a block diagram of an alternate exemplary lightweight USB compound device controller that uses an internal parsing circuit to extract information to be compared to a look-up table;

FIG. 5 is a flowchart illustrating an exemplary process for using a parsing circuit with a device controller to enable a lightweight USB compound device controller; and

FIG. 6 is a block diagram of an exemplary processor-based system that can include the lightweight USB compound device controller of FIGS. 3 and 4.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include a lightweight Universal Serial Bus (USB) compound device implementation. In particular, a compound device is provided that includes a parsing circuit that parses addresses and endpoint values for comparison to a look-up table and translation thereof for provision of updated addresses and endpoint values to a USB device controller. The USB device controller then uses the updated endpoint values to route information to a correct destination. In this manner, the benefits of a USB compound device are provided without the area and power penalty that normally accompanies a USB compound device.

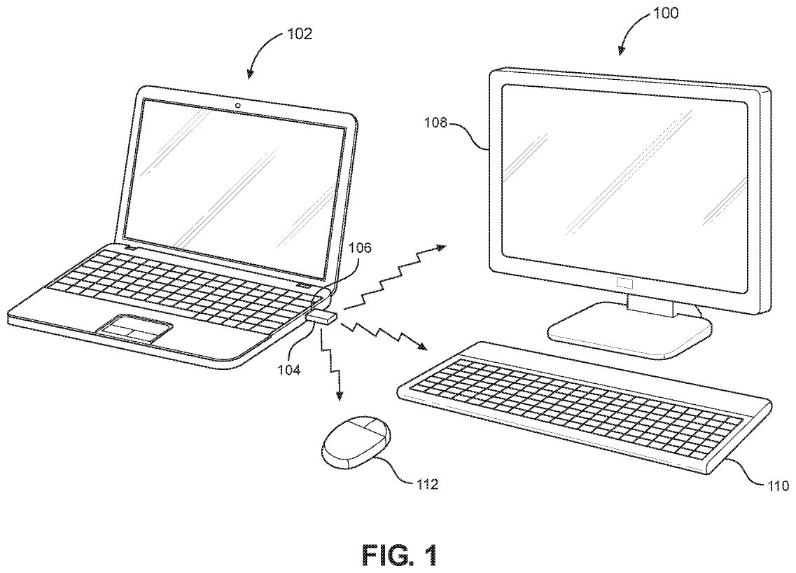

In this regard, FIG. 1 is a simplified illustration of a computing system 100 having a portable computing device 102, such as a laptop or the like, connected to a plurality of devices through a USB connection 104 plugged into a USB receptacle 106. In an exemplary aspect, the plurality of devices may be a monitor 108, a keyboard 110, and a mouse 112 that communicate wirelessly with the USB connection 104. The USB connection 104 may be a lightweight USB compound device controller according to exemplary aspects of the present disclosure. While the computing system 100 contemplates wireless connections from the USB connection 104 to the plurality of devices, other exemplary computing systems may be wired connections without departing from the present disclosure. Likewise, while the plurality of devices is illustrated as being external to the portable computing device 102, exemplary aspects may also be applicable to devices that are positioned internally to the portable computing device 102 but connected via a USB connection. Other exemplary devices may be a debug device, a device firmware update device, a mission mode device, or the like.

Conventional systems would have the USB connection be a composite or a compound device controller. A composite USB device integrates several functions into the same USB device and occupies only a single USB device address of the host. A composite device uses a single hardware controller. In use, the composite device is designed to work with a finite set of configurations, each of which is prepopulated within the controller. The requirement to prepopulate such configurations limits the flexibility of such devices as users cannot associate more devices or different configurations of devices than were originally contemplated.

In contrast, a compound device consists of a USB hub and several USB devices contained in a single physical device. The hub and devices are each allocated a different address on the USB tree, but typically require multiple USB device controllers, a hub controller, and the like. This duplication of controllers consumes space and increases the cost of such devices. Compound devices have advantages over composite devices in that they can enumerate multiple devices which do not have to be prepopulated. This flexibility allows each USB function to be implemented as an independent library, and the devices can be added or removed at run time without affecting other functions. Likewise, this flexibility allows simplification of host drivers, because each device can have a unique vendor identification (VID) or product identification (PID). The unique identification may help avoid driver conflicts. Still further, a compound device may postpone enumeration of the customer device and have a relaxed suspend current limit. A further benefit of the compound device is that charging is decoupled from the USB function, and thus, devices can still charge by the suspend current even when other functions are disabled.

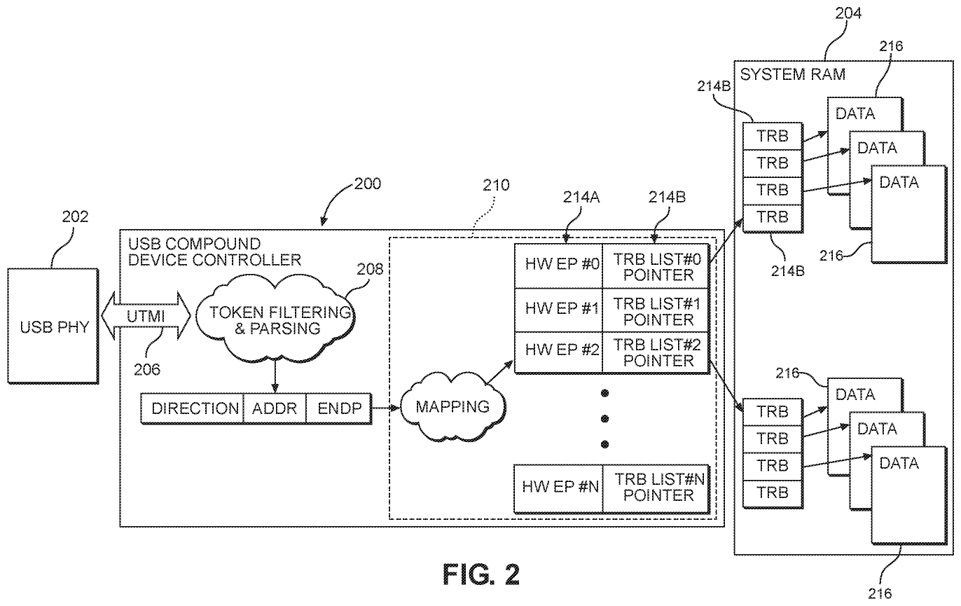

FIG. 2 shows a conventional compound device controller 200 associated with a USB physical layer (PHY) 202 and system memory 204 (e.g., random access memory (RAM)). The USB PHY 202 is coupled to a USB receptacle (not shown) and is thus configured to be coupled to a USB cable (also not shown) or other USB appliance. The USB PHY 202 is coupled to the compound device controller 200 through a USB Transceiver Macrocell Interface (UTMI) bus 206. The compound device controller 200 includes a token filtering and parsing circuit 208 that parses tokens by direction (incoming or outgoing), address (ADDR), and endpoint value (ENDP). If the address is unknown, then the token filtering and parsing circuit 208 filters out the token. If the token is incoming, then the address and the endpoint value are mapped to a transfer ring block (TRB) pointer such as through a table 210. The endpoint value 214A and the TRB pointer 214B are used as part of a direct memory access (DMA) to/from data buffers 216 within the system memory 204 as identified by the TRB pointers 214B.

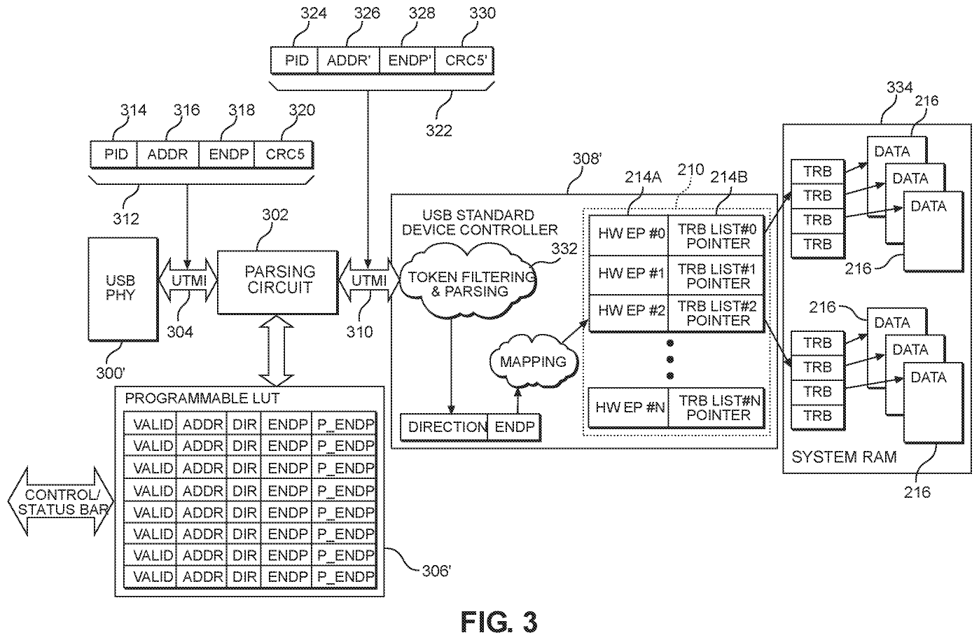

In contrast, exemplary aspects of the present disclosure provide a lightweight compound device controller that works with a parsing circuit between the PHY and the controller as illustrated in FIG. 3. In particular, a USB PHY 300 is coupled to a parsing circuit 302 by a UTMI bus 304. The parsing circuit 302 is coupled to a programmable look-up table (LUT) 306 and to a USB standard device controller 308 by a second UTMI bus 310. The USB PHY 300 passes a token 312 to the parsing circuit 302. The parsing circuit 302 may maintain a state to identify when a token is passed from the host to the device. The token 312 includes a PID 314, an address 316, an endpoint 318, and a cyclic redundancy check (CRC) 320. The parsing circuit 302 initially checks the address 316 to see if the address 316 is for a device associated with the device controller 308. The parsing circuit 302 checks the CRC 320 for validity, and if valid, the parsing circuit 302 uses the LUT 306 to see if the address 316 is present in the LUT 306. If the address 316 is not for a device associated with the device controller 308, the parsing circuit 302 merely passes the token through without modification. If, however, the address 316 does correspond to a device associated with the device controller 308, then the parsing circuit 302 manipulates the token. Specifically, the LUT 306 is used by the parsing circuit 302 to find the endpoint value to which the address is mapped. The parsing circuit 302 creates an updated or new token 322 with a PID 324 corresponding to the PID 314, an address prime field 326 (ADDR′), an endpoint prime field 328 (ENDP′), and a CRC prime field 330 (CRC5′). The values for the address prime field 326 and the endpoint prime field 328 are populated from the LUT 306. Note that the address prime field 326 will always have the address of the device controller 308 (rather than the actual destination device) populated thereinto. The device controller 308 takes the updated token 322 and parses it with a token filtering and parsing circuit 332 to determine a direction and an endpoint value as described above. The endpoint value (extracted from the endpoint prime field 328), is used to map to a TRB pointer for use in executing read/write commands to a system memory 334. It should be appreciated that the LUT 306 supports a three-part match for the direction field to enable control endpoints (which are bidirectional) to use a single LUT entry.

Instead of placing the parsing circuit 302 in the UTMI path, the parsing circuit 302 could remain in the device controller 308, but information would be passed to an external circuit and a LUT to find the modified address and endpoint. The modified address and endpoint are passed back to the device controller 308 for use as described above.

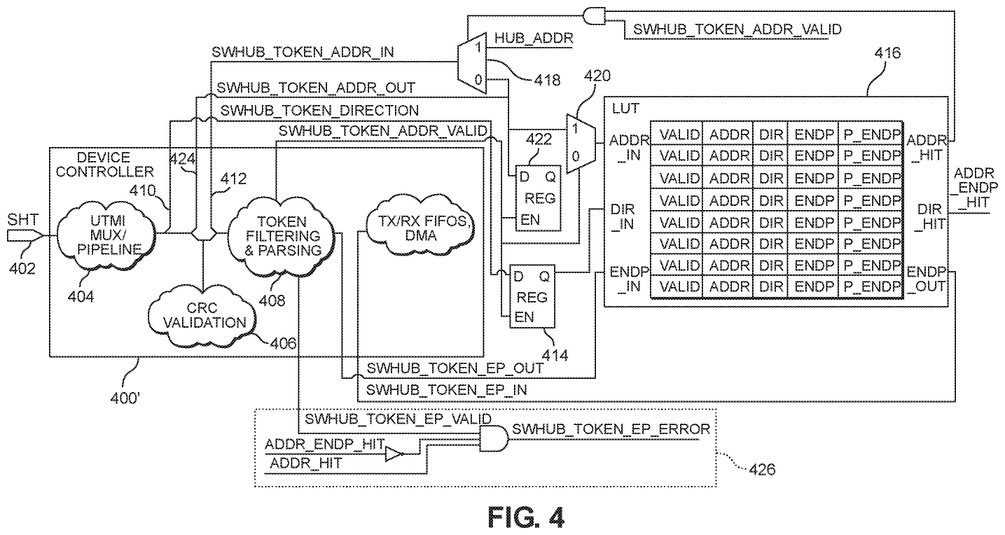

FIG. 4 illustrates a simplified block diagram of this aspect. In this regard, a device controller 400 receives data (e.g., UTM_RX_DATA) from a USB PHY (not shown) through a UTMI bus 402. The device controller 400 uses a UTMI multiplexer (MUX)/pipeline circuit 404 to handle the incoming data. A CRC validation circuit 406 checks the CRC value of incoming tokens. Note that the CRC check is done on all bits, including the token address. Before the tokens are parsed at a token filtering and parsing circuit 408, taps 410 and 412 are used to pull information from the device controller 400. The tap 410 checks for direction. A direction enabling circuit 414 receives a signal (SWHUB_TOKEN_DIRECTION) from the tap 410 and provides a direction indication to a LUT 416 at input DIR_IN based on the direction. The direction enabling circuit 414 also receives an indication (e.g., SWHUB_TOKEN_ADDR_VALID) that an address is valid from the token filtering and parsing circuit 408. The tap 412 takes the token and provides the token to a multiplexer 418, a multiplexer 420, and a circuit 422. The multiplexer 418 provides either the hub address or the value from the token (SW_TOKEN_ADDR_OUT) back to the device controller 400 through line 424. The AND gate at the top of the diagram bypasses the external logic when the device controller 400 is not parsing a token and is an optional part of the circuit. The multiplexer 420 provides an address to the LUT 416 at input ADDR_IN. The circuit 422 also receives the indication that the address is valid from the token filtering and parsing circuit 408 at input EN. The LUT 416 also receives the parsed token (SWHUB_TOKEN_EP_OUT) at input ENDP_IN from the token filtering and parsing circuit 408 and outputs an address hit signal from output ADDR_HIT to the multiplexer 418 and a modified endpoint value (SWHUB_TOKEN_EP_IN) from output ENDP_OUT to the device controller 400, where transmit/receive buffers may operate with direct memory access (DMA) as is understood. Additionally, an error circuit 426 may exist. An error signal indicates that the software did not configure the LUT 416 properly, and it can be used to trigger an interrupt.

The arrangement of FIG. 4 allows the device controller 400 to pipeline and decode the information on the interface from the USB PHY. Further, instead of replicating logic, tap, and override internal controller signals in the parsing circuit 302 of FIG. 3, these functions within the device controller 400 are used. This allows removal of a finite state machine, a pipeline, and a CRC calculator from the parsing circuit 302 compared to FIG. 3.

While the discussion of FIGS. 3 and 4 has described the UTMI bus, it should be appreciated that the present disclosure is not limited to UTMI buses. For example, the bus may comply with other protocols such as UTMI low pin interface (ULPI) or PHY interface for peripheral component interconnect (PCI) Express (PIPE) in the examples of USB superspeed or USB superspeed plus.

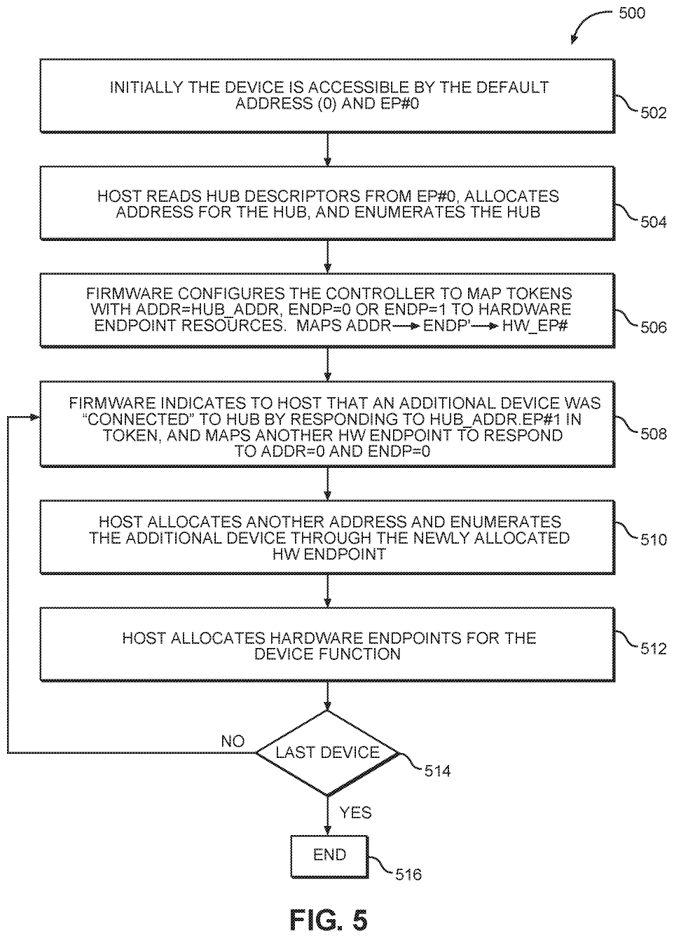

FIG. 5 provides a flowchart for a process 500 for using exemplary aspects of the present disclosure. The process 500 begins with a host being connected to a device and the device being accessible by the default address (0) and endpoint value (ENDP) (0 or EP#0) (block 502). It should be appreciated that the hub is the physical device that contains the device controller described above. The host reads the hub descriptors from EP#0, allocates an address for the hub, and enumerates the hub (block 504). The firmware of the hub configures the device controller to map tokens with ADDR=HUB_ADDR, ENDP=0, or ENDP=1 to hardware endpoint resources. The firmware further performs a double mapping function of ADDR.ENDP to ENDP′ to HW_EP# (block 506).

With continued reference to FIG. 5, the process 500 continues with the firmware indicating to the host that an additional device was “connected” to the hub by responding to a HUB_ADDR.EP#1 IN token, which indicates a hub status change event to the host, and maps another hardware endpoint to ADDR=0 and ENDP=0 (block 508).

The host allocates another address and enumerates the additional device through the newly allocated hardware endpoint (block 510). The firmware then allocates hardware endpoints and the double mapping for the device functions (block 512). The device checks to see if that was the last device (block 514). If the answer to block 514 is yes, the process 500 ends (block 516). Otherwise, the process 500 returns to block 508 for the next device.

The lightweight USB compound device implementation according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

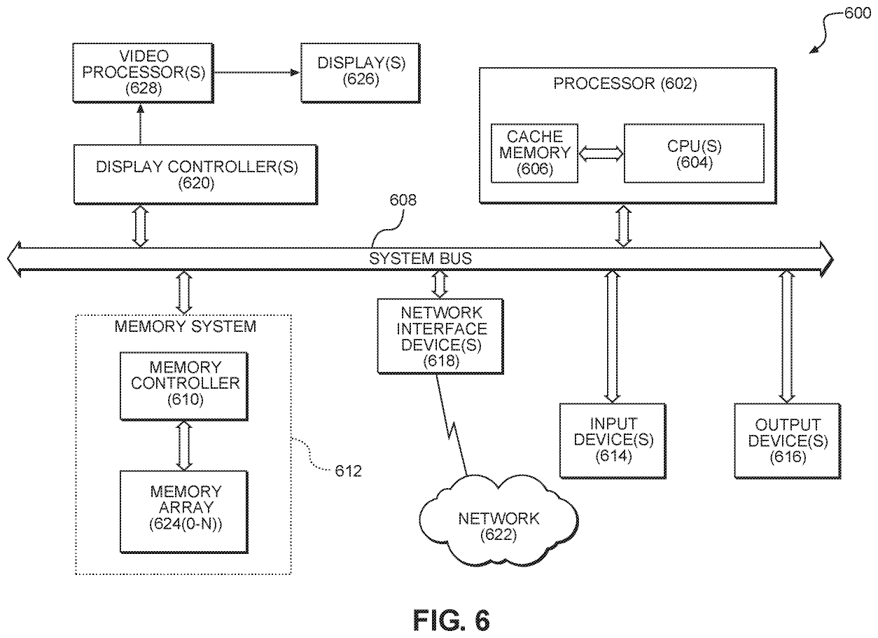

In this regard, FIG. 6 illustrates an example of a processor-based system 600 that can employ the lightweight USB compound device illustrated in FIGS. 3 and 4. In this example, the processor-based system 600 includes one or more central processing units (CPUs) 602, each including one or more processors 604. The CPU(s) 602 may have cache memory 606 coupled to the processor(s) 604 for rapid access to temporarily stored data. The CPU(s) 602 is coupled to a system bus 608 and can intercouple master and slave devices included in the processor-based system 600. As is well known, the CPU(s) 602 communicates with these other devices by exchanging address, control, and data information over the system bus 608. For example, the CPU(s) 602 can communicate bus transaction requests to a memory controller 610 as an example of a slave device. Although not illustrated in FIG. 6, multiple system buses 608 could be provided.

Other master and slave devices can be connected to the system bus 608. As illustrated in FIG. 6, these devices can include a memory system 612, one or more input devices 614, one or more output devices 616, one or more network interface devices 618, and one or more display controllers 620, as examples. The input device(s) 614 can include any type of input device, including, but not limited to, input keys, switches, voice processors, etc. The output device(s) 616 can include any type of output device, including, but not limited to, audio, video, other visual indicators, etc. The network interface device(s) 618 can be any devices configured to allow exchange of data to and from a network 622. The network 622 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 618 can be configured to support any type of communications protocol desired. The memory system 612 can include one or more memory units 624(0-N).

The CPU(s) 602 may also be configured to access the display controller(s) 620 over the system bus 608 to control information sent to one or more displays 626. The display controller(s) 620 sends information to the display(s) 626 to be displayed via one or more video processors 628, which process the information to be displayed into a format suitable for the display(s) 626. The display(s) 626 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. A method for using multiple Universal Serial Bus (USB) devices through a single USB receptacle on a host, the method comprising:
at a hub, receiving a token from a host;
checking a cyclic redundancy check (CRC) value;
when the CRC value is valid, replacing an address and an endpoint value within the token with a modified address and a modified endpoint value; and
passing an updated token to a device controller.

2. The method of claim 1, further comprising updating the CRC value based on the modified address and the modified endpoint value.

3. The method of claim 1, further comprising finding the modified address and the modified endpoint value in a look-up table.

4. The method of claim 1, further comprising tapping internal connections within the device controller to acquire the address and the endpoint value.

5. The method of claim 1, further comprising capturing the token from the host before the token reaches the device controller.

6. The method of claim 5, wherein capturing the token comprises placing a parsing circuit in a USB Transceiver Macrocell Interface (UTMI) bus between a USB physical layer (PHY) and the device controller.

7. The method of claim 5, wherein capturing the token comprises placing a parsing circuit in a UTMI low pin interface (ULPI) bus or a PHY interface for peripheral component interconnect (PCI) Express (PIPE) bus between a USB PHY and the device controller.

8. A Universal Serial Bus (USB) hub comprising:
a USB physical layer (PHY);
a first USB Transceiver Macrocell Interface (UTMI) bus coupled to the USB PHY;
a second UTMI bus;
a parsing circuit connected to the first UTMI bus and the second UTMI bus; and
a device controller coupled to the second UTMI bus;
wherein the parsing circuit is configured to:
receive a token from a host;
check a cyclic redundancy check (CRC) value;
when the CRC value is valid, replace an address and an endpoint value within the token with a modified address and a modified endpoint value; and
pass an updated token to the device controller.

9. The USB hub of claim 8, wherein the parsing circuit is further configured to update the CRC value based on the modified address and the modified endpoint value.

10. The USB hub of claim 8, further comprising a look-up table, and wherein the parsing circuit is further configured to find the modified address and the modified endpoint value in the look-up table.

11. The USB hub of claim 8, further comprising a tap configured to acquire the address and the endpoint value.

12. The USB hub of claim 8, wherein the parsing circuit is configured to capture the token from the host before the token reaches the device controller.

13. The USB hub of claim 12, wherein the parsing circuit is positioned in a USB Transceiver Macrocell Interface (UTMI) bus between the USB PHY and the device controller.

14. The USB hub of claim 12, wherein the parsing circuit is positioned in a UTMI low pin interface (ULPI) bus or a PHY interface for peripheral component interconnect (PCI) Express (PIPE) bus between the USB PHY and the device controller.

15. The USB hub of claim 8 integrated into an integrated circuit (IC).

16. The USB hub of claim 8 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

17. A Universal Serial Bus (USB) hub comprising:
a USB physical layer (PHY);
a USB Transceiver Macrocell Interface (UTMI) bus coupled to the USB PHY; and
a device controller coupled to the UTMI bus, the device controller comprising a parsing circuit and a pair of taps, the pair of taps providing information to a look-up table;
wherein the look-up table is configured to:
replace an address and an endpoint value within a token with a modified address and a modified endpoint value; and
pass an updated token to the device controller.

18. A Universal Serial Bus (USB) hub comprising:
a USB physical layer (PHY);
a first bus coupled to the USB PHY;
a second bus;
a parsing circuit connected to the first bus and the second bus; and
a device controller coupled to the second bus;
wherein the parsing circuit is configured to:
receive a token from a host;
check a cyclic redundancy check (CRC) value;
when the CRC value is valid, replace an address and an endpoint value within the token with a modified address and a modified endpoint value; and
pass an updated token to the device controller.

19. The USB hub of claim 18, wherein the first bus is selected from a group consisting of a USB Transceiver Macrocell Interface (UTMI) bus, UTMI low pin interface (ULPI) bus, and a PHY interface for peripheral component interconnect (PCI) Express (PIPE) bus.

20. The USB hub of claim 18, wherein the second bus is selected from a group consisting of a USB Transceiver Macrocell Interface (UTMI) bus, UTMI low pin interface (ULPI) bus, and a PHY interface for peripheral component interconnect (PCI) Express (PIPE) bus.
